(19) United States
(12) Patent Application Publication
(10) Pub. No.: US 2012/0262301 A1
(43) Pub. Date: Oct. 18, 2012

(54) Battery compartment adapted object locating device

(76) Inventors: Raymond F. Davidson, Hibbing, MN (US); John T. St. Ledger, Ham Lake, MN (US)

(21) Appl. No.: 13/089,294

(22) Filed: Apr. 18, 2011

(51) Int. Cl. G08B 21/00

(52) U.S. Cl. 340/657

(57) ABSTRACT

An object locating device containing a transmitter, receiver, and adapted battery. The receiver and adapted battery are sized to correspond to a standard sized battery and fit into the battery compartment of the object to be located. The transmitter, when activated, emits a radio frequency that is received by the receiver. Upon receipt of this signal, receiver emits an audible tone allowing the user to locate a missing object. The receiver includes a power source, circuit board, and voltage bridge. Adapted battery contains an increased voltage to compensate for the loss of power from the receiver, wherein a user will remove two of the existing batteries from the device and replace them with adapted battery and receiver.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The present invention relates to a device used to locate a misplaced object, more specifically a device used to locate the remote control for an appliance.

### BACKGROUND OF THE INVENTION

In today's world many home entertainment and electrical appliances can be controlled by remote using radio-frequency (RF), infrared (IR) light, or Bluetooth. Frequently, the remote control is the only way to utilize the full capabilities of the corresponding device as certain menus and features can only be accessed using the remote control. Therefore, it is extremely important that individuals have access to the remote control.

Often times a remote control can become lost or misplaced. To aid in locating a lost or misplaced remote control several devices have been created to locate these missing remote controls. Most commonly, a transmitter is used to send a signal to a receiver affixed to the missing remote. Upon receiving this signal the transmitter will emit a tone allowing the user to locate the missing device. The receiver used in these devices is typically affixed to the remote using an adhesive or hook and loop type fastener and must be externally applied to the body of the remote. This configuration can be very cumbersome and affect the aesthetic and ergonomic properties of the remote control. Further, the receiver can easily become dislodged from the remote control as the adhesive and fastening elements age. Therefore, there exists a need for a more secure, ergonomic, and aesthetically pleasing configuration of a remote control transmitter and receiver combination.

### SUMMARY OF THE INVENTION

An object locating device is provided that replaces multiple batteries of the object with the combination of a receiver, adapted battery and transmitter. In operation a user will replace at least two of the object batteries contained in the object battery compartment with the receiver and adapted battery. More specifically, a receiver containing a power supply, circuit board and conductor are located within a shell shaped and sized to resemble a standard battery, an adapted battery with an increased voltage is sized to resemble a standard battery required by the object and a transmitter in remote communication with the receiver.

Object locating device includes a receiver, transmitter, and adapted battery. Transmitter includes an activation means. Activation means can be a button, switch, knob, or other similar mechanism a user may manipulate to activate a radio frequency signal from the transmitter. Upon engagement of the activation means, a radio frequency signal will be sent to receiver. Upon receipt of this signal, receiver will emit an audible tone allowing the user to locate the receiver.

Transmitter can be paired with one receiver or multiple receivers and can contain multiple activation means paired with a corresponding receiver. Therefore, a single transmitter can be used to locate multiple receivers allowing each receiver to be located individually. Transmitter can be powered by direct current using a battery or alternating current using a plug and power outlet. Transmitter may contain a learn function allowing it to recognize and learn the unique radio frequency of a given receiver. This learn function will allow a transmitter and receiver to properly pair and provide flexibility to the user should the exact communication signal between the receiver and transmitter need to be reprogrammed.

In the preferred embodiment of the transmitter according to the present invention, transmitter includes a power supply, switch, circuit board, radio frequency (RF) crystal and antenna. Power supply provides power to the various circuitry and components of transmitter. Power supply may be a battery providing direct current or a plug and outlet providing alternating current. The switch will be triggered by the activation means and allow power to enter the circuit board where it is directed throughout the circuit. Upon activation, an RF signal is generated by the connection of RF crystal to an integrated circuit and transmitted through the antenna. This RF signal can then be received by the receiver. The electrical circuitry of the transmitter may also include other electrical components such as inducers, capacitors, resistors necessary to balance the circuit, but not essential to overall function of the idea.

Receiver is shaped and sized to resemble a size AA, AAA, C, D or other standard battery and is placed into the battery compartment of the object in the place of a traditional battery. Receiver includes a negative end and positive end. Negative end is adapted and sized to resemble a negative end of a standard battery and be in communication with a spring type or other connection commonly found in an objects battery compartment. Positive end is adapted and sized to resemble the positive end, or button terminal end, of a standard battery and be in communication with the contact commonly found in an objects battery compartment.

Receiver includes a power source, circuit board, and conductor. Power source is housed within a compartment located in receiver and provides power to the circuit board. Power source can be any small disposable or rechargeable power supply that will fit within the required size of the receiver. In the preferred embodiment of the present invention, power source consists of a series of button cell or watch type batteries. Circuit board contains a radio frequency receiver and micro sounding device. Although a radio frequency receiver is preferred other types of wireless communication may be used. Conductor acts as a voltage bridge allowing current to flow from adapted battery to the object along its desired path.

In the preferred embodiment of the receiver according to the present invention, receiver includes a power source, a first circuit board, a second circuit board, a sounder, an antenna, and a RF crystal. Power source provides electrical energy to the circuit. Antenna will receive a signal from the transmitter. This signal will be received through the antenna and decoded by the combination of the RF crystal and an integrated circuit. This received signal will then trigger sounder through a connection with the second circuit board. Sounder will emit an audible noise allowing it to be quickly located. Sounder may be a piezo buzzer, as it emits high sound output while maintaining a compact size. The electrical circuitry of receiver may also include other electrical components such as inducers, capacitors, resistors necessary to balance the circuit, but not essential to overall function of the idea.

A typical remote object will contain a battery compartment adapted to receive standard size batteries necessary to power the operation of the device. Typically, these batteries will be of the size AA, AAA, C, or D, although other combinations and sizes and batteries may be used. The present invention requires replacing these required batteries with the adapted battery and the receiver. Adapted battery is sized according to the required battery of the device and contains a negative end and positive button end. Adapted battery has at least twice the amount of volts contained in the standard battery size required by the object. In operation, a user will open the object battery compartment and insert receiver and adapted battery in the required orientation, the same way standard batteries would be placed into the object.

In the preferred embodiment of the present invention, receiver and adapted battery are sized to correspond to a size AA battery, as this is the most common battery size found in electronic remote controls. Adapted battery will have a voltage at least twice the standard voltage of 1.5 volts found in a typical AA battery, to compensate for the addition of the receiver.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 is a perspective view of device, according to the present invention;

FIG. 2 is a perspective view of the device, according to the present invention;

FIG. 3 is a side view of the receiver of the device, according to the present invention;

FIG. 4 is a schematic of one embodiment of the transmitter of the device, according to the present invention.

FIG. 5 is a schematic of one embodiment of the receiver of the device, according to the present invention.

FIG. 6 is a side view of the receiver and adapted battery of the device, according to the present invention.

### DETAILED DESCRIPTION OF THE INVENTION

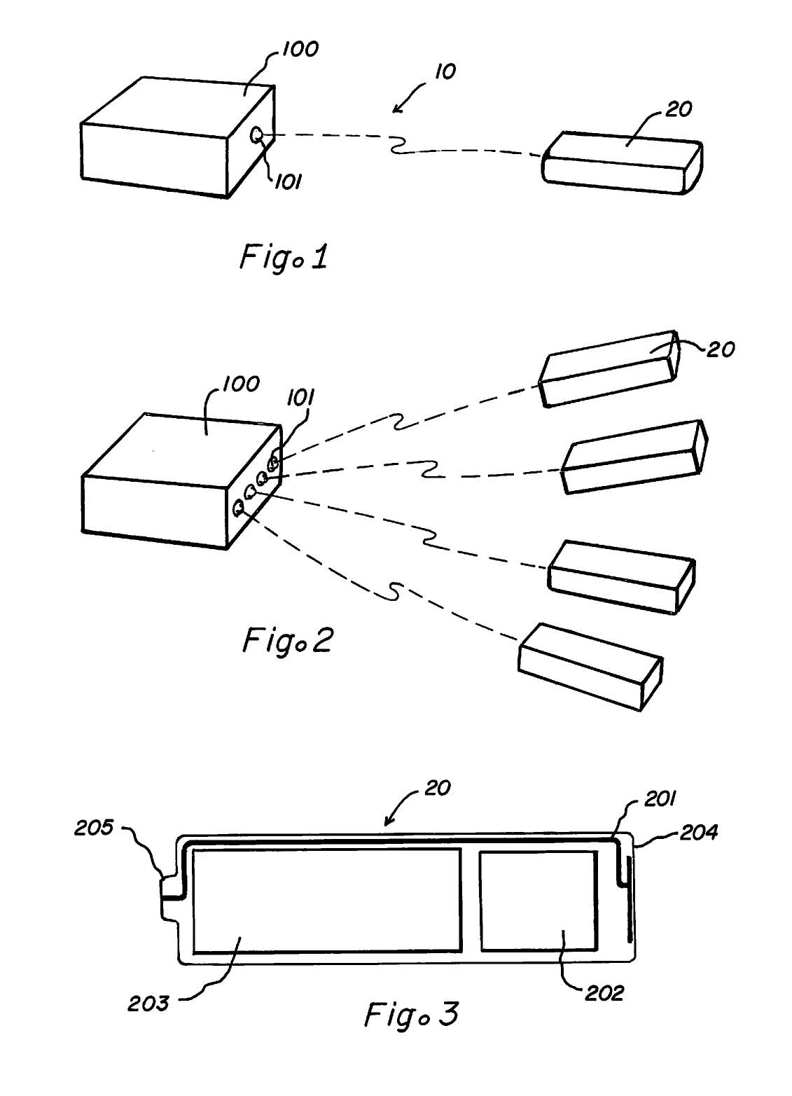

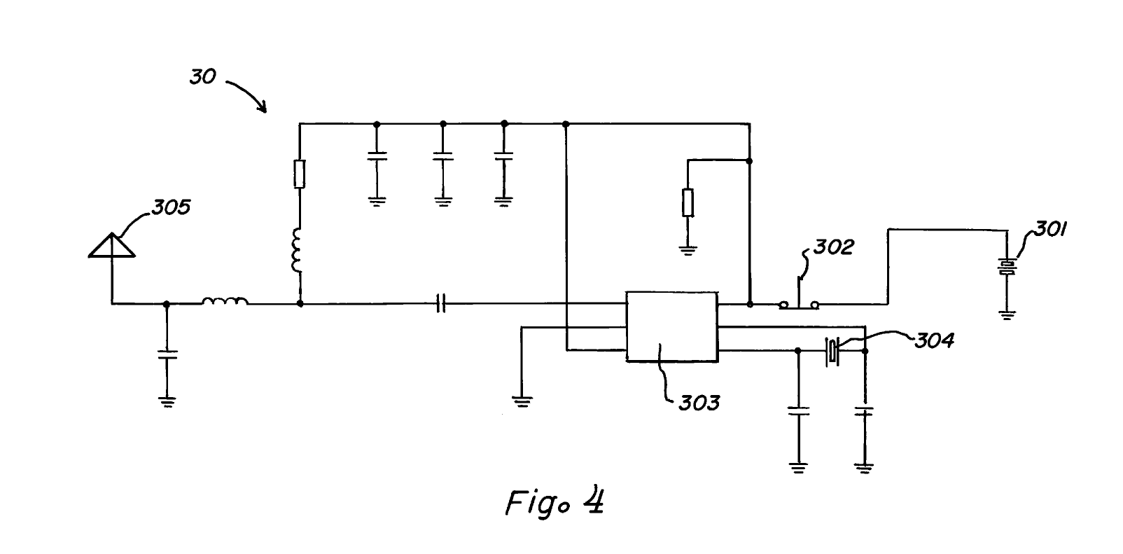

Referring now to FIGS. 1 and 2 there is shown an embodiment of the battery compartment adapted object locating device, generally designated by the reference numeral 10. Device 10 includes a receiver 20, transmitter 100, and battery (not pictured). Transmitter 100 includes an activation means 101. Activation means 101 can be a button, switch, knob, or other similar mechanism a user may manipulate to activate a signal from the transmitter 100. Upon engagement of the activation means 101, a signal will be sent to receiver 20. Upon receipt of this signal, receiver 20 will emit an audible tone allowing the user to locate the receiver 20.

Transmitter 100 can be paired with one receiver 20 or can contain multiple activation means 101 that will activate a signal in a corresponding receiver 20. Therefore, a single transmitter 100 can be used to locate multiple receivers 20 allowing each receiver 20 to be located individually. Transmitter 100 may contain a learn function allowing it to recognize and learn the unique radio frequency (RF) of a given receiver. This learn function will allow a transmitter and receiver to properly pair and provide flexibility to the user should the exact communication signal between the receiver and transmitter need to be reprogrammed. Transmitter 100 can be powered by direct current using a battery or alternating current using a plug and power outlet.

Referring now to FIG. 3 there is shown receiver 20. Receiver 20 is shaped to resemble a standard size AA, AAA, C, D or other standard battery and be placed into the battery compartment of the object in the place of a traditional battery. Receiver 20 includes a negative end 204 and positive end 205. Negative end 204 is adapted and sized to resemble a negative end of a standard battery and be in communication with a spring type or other connection commonly found in an objects battery compartment. Positive end 205 is adapted and sized to resemble the positive end, or button terminal end, of a standard battery and be in communication with the contact commonly found in an objects battery compartment.

Receiver 20 includes a power source 202, circuit board 203, and conductor 201. Power source 202 is housed within a compartment located in receiver 20 and provides power to circuit board 203. Power source 202 can be any small disposable or rechargeable power supply that will fit within the required size of receiver 20. In the preferred embodiment of the present invention, power source 202 consists of a series of button cell or watch type batteries. Circuit board 203 contains a radio frequency receiver, a crystal decoder, and micro sounding device. Although a radio frequency receiver is preferred other types of wireless communication may be used. Conductor 201 acts as a voltage bridge allowing current to normally flow from a battery to the object.

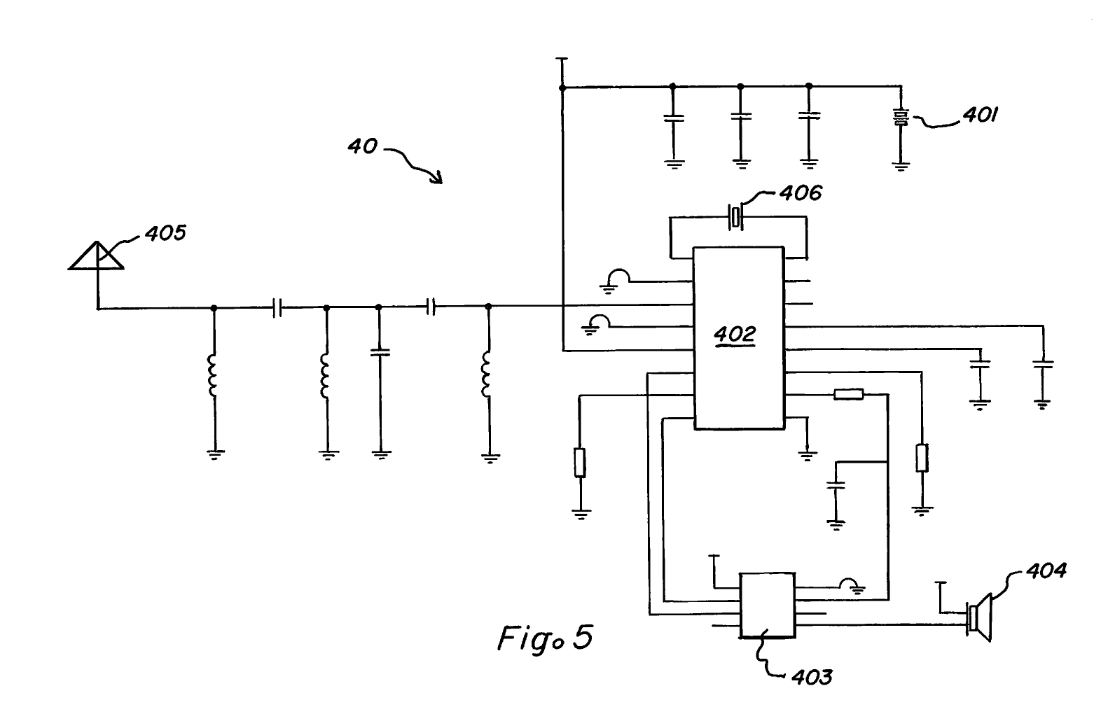

Referring now to FIG. 4, a schematic of one embodiment of the electrical components and connections of the transmitter generally designated by the reference numeral 30. Transmitter schematic 30 includes a power supply 301, switch 302, circuit board 303, radio frequency (RF) crystal 304 and antenna 305. Power supply 301 provides power to the various circuitry and components of transmitter 100. Power supply 301 may be a battery providing direct current or a plug and outlet providing alternating current. Switch 302 allows power to enter the circuit board 303 where power is directed throughout the circuit. RF crystal 304 in combination with an integrated circuit will produce the RF carrier signal that is transmitted through antenna 305. This RF signal can then be received by receiver 20. Schematic 30 includes additional inducers, capacitors, resistors, and other electrical components necessary to balance the circuit, but not essential to overall function of the idea.

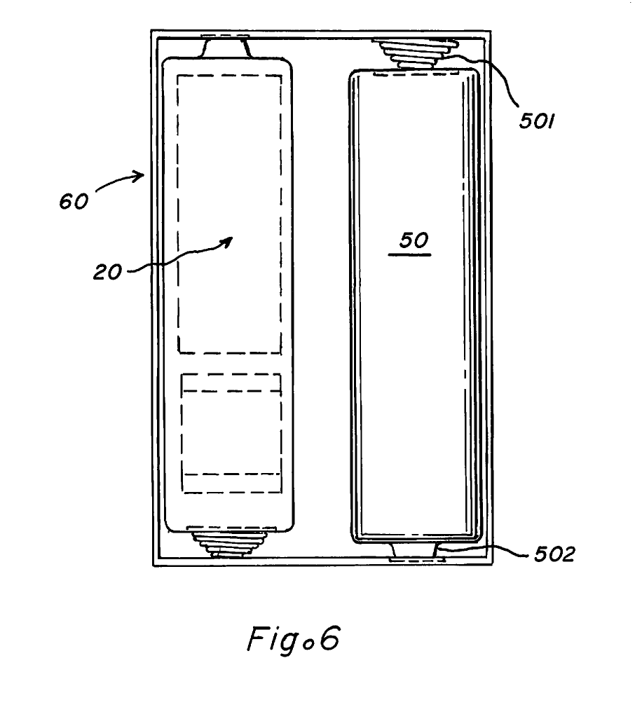

Referring now to FIG. 5, a schematic of one embodiment of the electrical components and connections of the receiver generally designated by the reference numeral 40 there is shown a power source 401, a first circuit board 402, a second circuit board 403, a sounder 404, an antenna 405, and a RF crystal 406. Power source 401 provides electrical energy to the circuit. In the preferred embodiment power source 401 consists of button type battery or series of button type batteries that deliver direct current to the circuit. Antenna 405 will receive a signal from transmitter 100. The signal received through antenna 405 will be interpreted and decoded by the combination of the RF crystal 406 and an integrated circuit. This receipt of a valid signal will then trigger sounder 404 through a connection with second circuit board 403. Sounder 404 will emit an audible noise allowing it to be quickly located.

In the preferred embodiment sounder 404 is piezo buzzer. The piezo buzzer is preferred as it emits high sound output while maintaining a compact size. Schematic 40 includes additional inducers, capacitors, resistors, and other electrical components necessary to balance the circuit, but not essential to overall function of the idea.

Schematic 30 and schematic 40 provide one exemplary circuit that will produce a RF signal that can be received. Other circuit designs and components and there accompanying schematics may be required to produce some features of the present invention. The alterations to the circuitry to execute some features will be known to those skilled in the art.

Referring now to FIG. 6, there is shown receiver 20, adapted battery 50, and object battery compartment 60. Battery compartment 60 is present in the object and receives the correct size and type of batteries the object requires to be properly operated. In a typical object, battery compartment will contain two AA, AAA, C, or D sized batteries, although other combinations and sizes and batteries may be used. The present invention requires replacing the required batteries with adapted battery 50 and receiver 20. Adapted battery 50 contains a negative end 501 and positive button end 502. Adapted battery 50 is sized to correspond to a standard battery size such as AA, AAA, C, and D. Adapted battery 50 has at least twice the amount of volts contained in the standard battery size required by the object. In operation, a user will open the object battery compartment and insert receiver 20 and adapted battery 50 in the required orientation, the same way standard batteries would be placed into the object.

In the preferred embodiment of the present invention, receiver 20 and adapted battery 50 are sized to correspond to a size AA battery, as this is the most common battery size found in electronic remote controls. Adapted battery 50 will have a voltage at least twice the standard voltage of 1.5 volts found in a typical AA battery, to compensate for the addition of receiver 20.

1. A remote object locating device comprising:
a transmitter, the transmitter emitting a radio frequency;
a receiver, the receiver having a size corresponding to a standard battery, and adapted to receive the radio frequency; and
a battery, wherein the receiver and battery will be received within the battery compartment of the object to be located.

2. A remote object locating device as claimed in claim 1, wherein the receiver contains a power source, circuit board, and conductor, the conductor acting as a voltage bridge between the battery and the object.

3. A remote object locating device as claimed in claim 1, wherein the transmitter emits more than one radio frequency.

4. A remote object locating device as claimed in claim 3, wherein the receiver can learn the radio frequency of the transmitter.

5. A remote object locating device as claimed in claim 1, wherein the receiver and battery are shaped and sized to resemble a AA battery.

6. A remote object locating device as claimed in claim 1, wherein the receiver and battery are shaped and sized to resemble a AAA battery.

7. A remote object locating device as claimed in claim 1, wherein the receiver and battery are shaped and sized to resemble a C battery.

8. A remote object locating device as claimed in claim 1, wherein the receiver and battery are shaped and sized to resemble a D battery.

9. A remote object locating device as claimed in claim 2, wherein the power source is replaceable.

10. A remote object locating device comprising:
a transmitter, the transmitter having a power source, a crystal emitting a radio frequency, a circuit board, a switch, the switch allowing power to enter the circuit board, a antenna, the antenna capable of broadcasting the radio frequency;
a receiver, the receiver having a size corresponding to the size of the battery required by the object, a power source, a circuit board, a conductor bridging a negative terminal and a positive terminal, and adapted to receive the radio frequency; and
a battery, the battery having a size corresponding to the size of the battery required by the object, and having a voltage at least twice the required voltage of a single battery required by the object.

11. A remote object locating device as claimed in claim 10, wherein the transmitter emits more than one radio frequency.

12. A remote object locating device as claimed in claim 11, wherein the receiver can learn the radio frequency of the transmitter.

13. A remote object locating device as claimed in claim 10, wherein the receiver and battery are shaped and sized to resemble a AA battery.

14. A remote object locating device as claimed in claim 10, wherein the receiver and battery are shaped and sized to resemble a AAA battery.

15. A remote object locating device as claimed in claim 10, wherein the receiver and battery are shaped and sized to resemble a C battery.

16. A remote object locating device as claimed in claim 10, wherein the receiver and battery are shaped and sized to resemble a D battery.

17. A remote object locating device as claimed in claim 10, wherein the power source is replaceable.
